(19) United States
(12) Patent Application Publication
(10) Pub. No.: US 2016/0064730 A1
(43) Pub. Date: Mar. 3, 2016

(54) COMPOSITE POSITIVE ELECTRODE ACTIVE MATERIAL AND POSITIVE ELECTRODE AND LITHIUM BATTERY COMPRISING THE COMPOSITE POSITIVE ELECTRODE ACTIVE MATERIAL

(71) Applicant: SAMSUNG SDI CO., LTD., Yongin-si (KR)

(72) Inventors: Haneol PARK, Yongin-si (KR); Seonyoung KWON, Yongin-si (KR); Minhan KIM, Yongin-si (KR); Jihyun KIM, Yongin-si (KR); Joong-Ho MOON, Yongin-si (KR); Kyounghyun KIM, Yongin-si (KR); Dohyung PARK, Yongin-si (KR); Jongseo CHOI, Yongin-si (KR)

(21) Appl. No.: 14/688,277

(22) Filed: Apr. 16, 2015

(30) Foreign Application Priority Data
Aug. 28, 2014 (KR) 10-2014-0113354

(51) Int. Cl. H01M 4/36; H01M 10/0525; H01M 4/58; H01M 4/525; H01M 4/505

(52) U.S. Cl. CPC H01M 4/366; H01M 4/525; H01M 4/505; H01M 4/5825; H01M 10/0525; H01M 2004/028

(57) ABSTRACT

A composite positive electrode active material includes a lithium transition metal oxide represented by at least one of LiNiₓCo_{y}Mn_{z}O₂ (Formula 1) and aLi₂MnO₃.(1−a)LiMO₂ (Formula 2). In Formula 1, and a vanadium-based compound including a polyanion. In Formula 1, 0<x≦0.8, 0<y≦0.5, and 0<z≦0.5. In Formula 2, 0<a<1 and M is at least one element selected from aluminum (Al), magnesium (Mg), manganese (Mn), cobalt (Co), chromium (Cr), vanadium (V), iron (Fe), and nickel (Ni).

### CROSS-REFERENCE TO RELATED APPLICATION

Korean Patent Application No. 10-2014-0113354, filed on Aug. 28, 2014, in the Korean Intellectual Property Office, and entitled: “Composite Positive Electrode Active Material and Positive Electrode and Lithium Battery Comprising the Composite Positive Electrode Active Material,” is incorporated by reference herein in its entirety.

### BACKGROUND

1. Field

One or more embodiments relate a composite positive electrode active material, and a positive electrode and a lithium battery that include the composite positive electrode active material.

2. Description of the Related Art

A lithium battery includes a positive electrode and a negative electrode, which include an active material capable of intercalation and deintercalation of lithium ions, and an organic electrolyte or a polymer electrolyte filled between the positive electrode and the negative electrode. In this configuration of the lithium battery, electrical energy is generated by oxidation and reduction upon the intercalation or deintercalation of lithium ions in the positive electrode and the negative electrode.

### SUMMARY

Embodiments are directed to a composite positive electrode active material including a lithium transition metal oxide represented by at least one of Formulae 1 and 2 below, and a vanadium-based compound including a polyanion,

LiNiₓCo_{y}Mn_{z}O₂ <Formula 1>

In Formula 1, 0<x≦0.8, 0<y≦0.5, and 0<z≦0.5

aLi₂MnO₃.(1−a)LiMO₂ <Formula 2>

In Formula 2, 0<a<1 and M is at least one element selected from aluminum (Al), magnesium (Mg), manganese (Mn), cobalt (Co), chromium (Cr), vanadium (V), iron (Fe), and nickel (Ni).

The vanadium-based compound may include a PO₄³⁻ polyanion.

The vanadium-based compound may include Li₃V₂(PO₄)₃.

The vanadium-based compound may be included as particles having a bimodal particle diameter distribution.

The particles in the bimodal particle distribution may include large particles having an average particle diameter (D50) in a range of about 7 μm to about 20 μm.

The particles in the bimodal particle diameter distribution may include the large particles and may further include small particles having an average particle diameter D50 in a range of about 0.1 μm to about 10 μm.

The vanadium-based compound may be included in a range of about 0.1 parts to about 40 parts by weight based on 100 parts by weight of a total weight of the composite positive electrode active material.

The lithium transition metal oxide may be included as particles having an average particle diameter D50 in a range of about 10 μm to about 20 μm.

The vanadium-based compound may be coated on at least a portion of a surface of the lithium transition metal oxide.

The vanadium-based compound may be discontinuously coated on a surface of the lithium transition metal oxide.

The vanadium-based compound may be included in a range of about 0.01 parts to about 20 parts by weight based on 100 parts by weight of a total weight of the composite positive electrode active material.

Embodiments are also directed to a lithium battery including a positive electrode including the composite positive electrode active material, a negative electrode facing the positive electrode, an electrolyte between the positive electrode and the negative electrode.

### BRIEF DESCRIPTION OF THE DRAWINGS

Features will become apparent to those of skill in the art by describing in detail exemplary embodiments with reference to the attached drawings in which:

FIG. 1 illustrates a scanning electron microscopy (SEM) image of a vanadium-based compound included in a composite positive electrode active material according to an embodiment;

FIG. 2 illustrates an SEM image of a lithium transition metal oxide included in a composite positive electrode active material according to an embodiment;

FIG. 3 illustrates an SEM image of a composite positive electrode active material prepared according to Example 5;

FIG. 4 illustrates an exploded perspective view of a lithium battery according to an embodiment;

FIG. 5A illustrates a graph showing differential scanning calorimetry (DSC) measurements in lithium batteries prepared according to Examples 9-12 and Comparative Examples 3 and 4;

FIG. 5B illustrates a graph showing DSC measurements in lithium batteries prepared according to Examples 14-16 and Comparative Example 3; and

FIG. 6 illustrates a graph showing charge-discharge capacity of lithium batteries prepared according to Examples 9-12 and Comparative Example 3.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. As used herein, the term “and/or” includes any and all combinations of one or more of the associated listed items. Expressions such as “at least one of” when preceding a list of elements, modify the entire list of elements and do not modify the individual elements of the list.

According to an aspect, there is provided a composite positive electrode active material including: a lithium transition metal oxide represented by at least one of Formulae 1 and 2 below; and a vanadium-based compound including a polyanion:

LiNiₓCo_{y}Mn_{z}O₂ <Formula 1>

In Formula 1, 0<x≦0.8, 0<y≦0.5, and 0<z≦0.5

aLi₂MnO₃.(1−a)LiMO₂ <Formula 2>

In Formula 2, 0<a<1 and M is at least one element selected from the group of aluminum (Al), magnesium (Mg), manganese (Mn), cobalt (Co), chromium (Cr), vanadium (V), iron (Fe), and nickel (Ni).

The lithium transition metal oxide of at least one of Formulae 1 and 2 may have a layered structure. For example, in the case of the lithium transition metal oxide represented by Formula 1, Ni²⁺ may changed to Ni³⁺ or Ni⁴⁺ according to the depth of charge during charging.

However, unlike Ni²⁺, which is stable, Ni³⁺ or Ni⁴⁺ may lose lattice oxygen due to the instability thereof and may be reduced to Ni²⁺. Such lattice oxygen may react with an electrolyte to change the surface properties of an electrode or to increase a charge transfer impedance on the surface of the electrode. Accordingly, the lithium transition metal oxide may have reduced capacity and thermal stability as compared with those of a lithium transition metal oxide having a spinel-like structure.

In some embodiments, the composite positive electrode active material may include a polyanion. For example, the composite positive electrode active material may be a vanadium-based compound including a phosphate-containing polyanion, or sulfate-containing a polyanion, which have a high theoretical capacity and an equivalent or higher gravimetric energy density than lithium manganese oxide. In this regard, a lithium battery including the composite positive electrode active material may have excellent thermal stability and high energy density.

The vanadium-based compound may include a PO₄³⁻ polyanion. Lithium intercalation and deintercalation potentials of the vanadium-based compound including the PO₄³⁻ polyanion may be close to the potentials of the lithium cobalt oxide (LiCoO₂). Up to 1.5 lithium atoms may be operable with respect to each vanadium atom. In this regard, the vanadium-based compound may have a high theoretical capacity of about 197 mAh/g. Thus, a lithium battery including the vanadium-based compound as a positive electrode active material may improve thermal stability and maintain high capacity of the lithium battery.

The vanadium-based compound may include, for example, Li₃V₂(PO₄)₃. The vanadium-based compound may have a monoclinic structure having excellent thermal stability. A lithium battery employing the composite positive electrode active material that includes the vanadium-based compound may have excellent thermal stability.

The vanadium-based compound may have a bimodal particle diameter distribution thereof. The vanadium-based compound may have a bimodal particle diameter distribution including large particles and small particles. Voids between particles of the lithium transition metal oxide may be densely filled. Accordingly, the composite positive electrode active material including the vanadium-based compound may be able to have a high gravimetric energy density.

The vanadium-based compound may include large particles having an average particle diameter (referred to as “D50”) in a range of about 7 μm to about 20 μm, for example, about 7 μm to about 10 μm, for example, 7 μm to about 9 μm. The vanadium-based compound may include small particles having an average particle diameter D50 in a range of about 0.1 μm to about 10 μm, for example, about 0.1 μm to about 3 μm, for example, about 1 μm to about 3 μm.

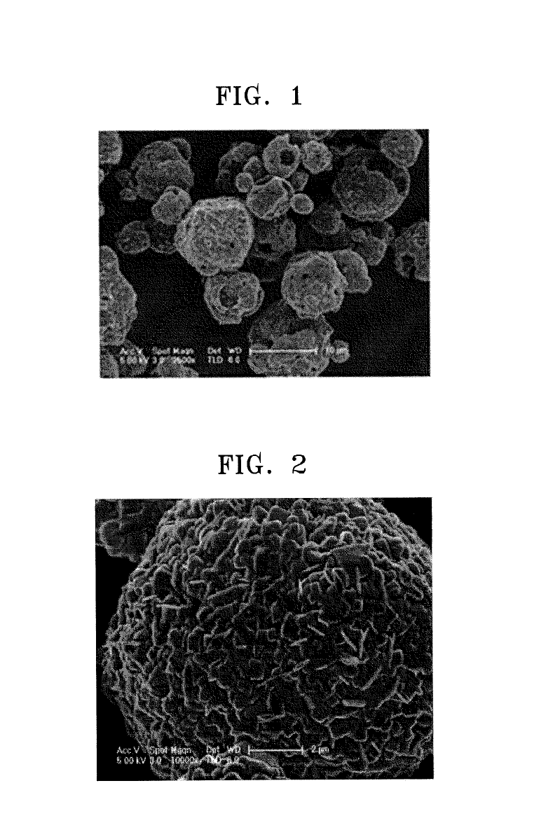

As an explanation of the term “average particle diameter D50” used herein, if the total volumes of particle diameters are considered to be 100%, an average value of the particle diameters at 50 volume % may be accumulated in a cumulative distribution curve. The average particle diameter D50 may be measured by methods that are widely known in the art, but may be also measured according to transmission electron microscopy (TEM) or scanning electron microscopy (SEM). The average particle diameter D50 of the vanadium-based compound may be confirmed by the SEM image of FIG. 1.

The vanadium-based compound having the average particle diameter D50 within the range above may be able to more efficiently fill voids between particles of the lithium transition metal oxide to be densely filled. Accordingly, a lithium battery including the composite positive electrode active material that includes the vanadium-based compound may ensure a high capacity.

When the vanadium-based compound is provided in the form of particles, the amount of the vanadium-based compound may be in a range of, for example, about 0.1 to about 50 parts by weight, or 0.1 parts to about 40 parts by weight, or about 1 part to about 30 parts by weight or about 3 parts to about 30 parts by weight, based on 100 parts by weight of the total weights of the composite positive electrode active material. The composite positive electrode active material including the vanadium-based compound in an amount within the above-described ranges may further improve thermal stability and energy density. A lithium battery including the composite positive electrode active material may be able to maintain a very high capacity.

The average particle diameter D50 of the lithium transition metal oxide may be in a range of about 10 μm to about 20 μm, for example, about 10 μm to about 16 μm. The lithium transition metal oxide having the average particle diameter D50 within the above-described ranges may exhibit excellent cell performance characteristics.

The vanadium-based compound may be coated on at least a portion of a surface of the lithium transition metal oxide. The vanadium-based compound may easily provide thermal stability at high temperatures.

The vanadium-based compound may be discontinuously coated on a surface of the lithium transition metal oxide. For example, a large amount or a small amount of the vanadium-based compound may be irregularly or discontinuously coated on a surface of the lithium transition metal oxide.

When the vanadium-based compound is provided in the form of a discontinuous coating on a surface of the lithium transition metal oxide, the amount of the vanadium-based compound may be in a range of, for example, about 0.01 parts to about 30 parts by weight, 0.01 parts to about 20 parts by weight, or, about 0.05 parts to about 10 parts by weight, based on 100 parts by weight of the total weight of the composite positive electrode active material.

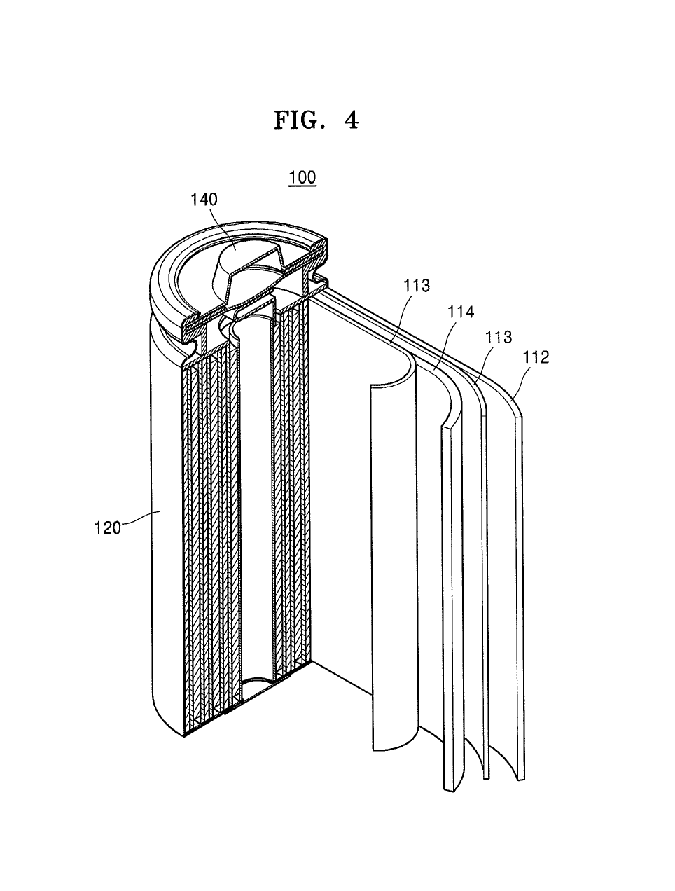

In comparison with a composite positive electrode active material prepared by mixing of the lithium transition metal oxide and the vanadium-based compound, a composite positive electrode active material that is prepared by being coated with the vanadium-based compound on a surface of the lithium transition metal oxide may have more efficiently filled spaces on a surface between the particles for forming the lithium transition metal oxide in spite of the lesser amount of the vanadium-based compound included therein. Such a composite positive electrode active material may be more efficient in terms of thermal stability and capacity retention. The composite positive electrode active material coated with the vanadium-based compound on a surface of the lithium transition metal oxide may be confirmed by the SEM image of FIG. 3 as described below.

According to another aspect, there is provided a method of preparing a composite positive electrode active material including preparing a lithium transition metal oxide represented by at least one of Formulae 1 and 2 below, preparing a vanadium-based compound including a PO₄³⁻ polyanion, and mixing the lithium transition metal oxide with the vanadium-based compound including a PO₄³⁻ polyanion:

LiNiₓCo_{y}Mn_{z}O₂ <Formula 1>

In Formula 1, 0<x≦0.8, 0<y≦0.5, and 0<z≦0.5

aLi₂MnO₃.(1−a)LiMO₂ <Formula 2>

In Formula 2, 0<a<1 and M is at least one element selected from the group of Al, Mg, Mn, Co, Cr, V, Fe, and Ni.

The lithium transition metal oxide represented by at least one of Formulae 1 and 2 may be prepared by a suitable process. For example, the lithium transition metal oxide may be prepared by, for example, a co-precipitation process using a precursor of the lithium transition metal oxide represented by at least one of Formulae 1 and 2.

The lithium transition metal oxide may have an average particle diameter D50 in a range of about 10 μm to about 20 μm, for example, about 10 μm to about 16 μm.

The vanadium-based compound including a PO₄³″ polyanion may be prepared by a suitable process. For example, the vanadium-based compound including a PO₄³⁻ polyanion may be prepared by using a solid-phase reaction method, a liquid-phase reaction method, a sol-gel method, a hydrothermal method, or the like. For example, the vanadium-based compound may be prepared by using a solid-phase reaction method.

In some embodiments, the composite positive electrode active material may be prepared in the following manner:

A mixture of a lithium-containing compound, a vanadium-containing compound, and a reducing agent may be prepared.

The lithium-containing compound may be at least one selected from the group of LiOH, LiOH.H₂O, LiNO₃, Li₂CO₃, CH₃COOLi.2H₂O, Li₂SO₄.H₂O, and Li₂C₂O₄. For example, the lithium-containing compound may be at least one selected from the group of LiOH, LiOH, H₂O, LiNO₃, and Li₂CO₃.

The vanadium-containing compound may be at least one selected from the group of V₂O₅, V₂O₃, V₂O₄, NH₄VO₃, vanadium(III) acetylacetonate, and vanadium (IV) oxyacetylacetonate. For example, the vanadium-containing compound may be at least one selected from the group of V₂O₅, V₂O₃, V₂O₄, and NH₄VO₃.

The amount of the vanadium-containing compound may be in a range of about 1.9 mol to about 2.1 mol, for example, about 1.95 mol to about 2.05 or about 1.98 mol to about 2.02 mol, based on 1.5 mol of the lithium-containing compound.

When the amount of the vanadium-containing compound is within the ranges above, the vanadium-based compound may improve the thermal stability and energy density of the composite positive electrode active material, and accordingly, a lithium battery including such a composite positive electrode active material may be able to maintain a very high capacity.

The reducing agent may be at least one selected from the group of H₃PO₃, (NH₄)H₂PO₃, (NH₄)₂HPO₃, (NH₄)₃PO₃, H₃PO₂, (NH₄)H₂PO₂, (NH₄)₂HPO₄, and (NH₄)₃PO₂. For example, the reducing agent may be at least one selected from the group of (NH₄)₂HPO₃, (NH₄)₃PO₃, H₃PO₂, (NH₄)H₂PO₂, and (NH₄)₂HPO₄.

The amount of the reducing agent may be in a range of about 2.9 mol to about 3.1 mol, for example, about 2.95 mol to about 3.05 mol or about 2.98 mol to about 3.02 mol, based on 1.5 mol of the of the lithium containing compound.

When the amount of the reducing agent is within the ranges above, a sufficient content of the vanadium-based compound may be obtained.

The mixture may further include, as a solvent, water or a C1-C10 aliphatic alcohol such as methanol, ethanol, propanol (e.g., n-propanol or iso-propanol), or butanol (e.g., n-butanol or iso-butanol).

The mixture may be dried to obtain a dry product. The drying of the mixture may result in a production of a solid compound by a suitable method. For example, the drying of the mixture may be performed by using spray drying, freeze drying, or a combination thereof.

The dry product may be sintered to obtain a vanadium-based compound including a PO₄³⁻ polyanion. Obtaining the vanadium-based compound including a PO₄³⁻ polyanion may include sintering the dry product at a temperature in a range of about 700° C. to about 1,000° C., for example, about 700° C. to about 900° C.

The sintering may be performed, for example, under an inert gas atmosphere for about 5 hours to about 20 hours, for example, about 7 hours to about 15 hours. The inert gas may be, for example, nitrogen gas, nitrogen and hydrogen gas, helium gas, and/or argon gas.

The vanadium-based compound may have a bimodal particle diameter distribution. The vanadium-based compound may include large particles having an average particle diameter D50 in a range of about 7 μm to about 10 μm, for example, about 7 μm to about 9 μm. The vanadium-based compound may include small particles having an average particle diameter D50 in a range of about 0.1 μm to about 3 μm, for example, about 1 μm to about 3 μm.

In the mixing of the lithium transition metal oxide with the vanadium-based compound including a PO₄³⁻ polyanion in the form of particles, the amount of the vanadium-based compound may be in a range of about 0.1 parts to about 50 parts by weight, for example, about 1 part to about 40 parts by weight or about 3 parts to about 40 parts by weight, based on 100 parts by weight of the composite positive electrode active material.

The composite positive electrode active material including the vanadium-based compound in the amount within the above-described ranges may further improve thermal stability and energy density. A lithium battery including the composite positive electrode active material may be able to maintain a very high capacity.

In some embodiments, a surface of the lithium transition metal oxide may be coated with the vanadium-based compound including a PO₄³⁻ polyanion. The coating may be performed by a suitable method, for example, by a dry coating, wet coating, or a ball-milling method.

In embodiments in which a surface of the lithium transition metal oxide is coated with the vanadium-based compound including a PO₄³⁻ polyanion, the amount of the vanadium-based compound may be in a range of 0.01 parts to about 30 parts by weight, for example, about 0.05 parts to about 20 parts by weight, based on 100 parts by weight of the composite positive electrode active material.

The composite positive electrode active material prepared by coating a surface of the lithium transition metal oxide with the vanadium-based compound may contain a lesser amount of the vanadium-based compound than a composite positive electrode active material prepared by mixing of the lithium transition metal oxide and the vanadium-based compound. The composite positive electrode active material prepared coating a surface of the lithium transition metal oxide with the vanadium-based compound may be more efficient in terms of thermal stability and capacity retention.

According to another embodiment, there is provided a lithium battery including: a positive electrode including the above-described composite positive electrode active material; a negative electrode facing the positive electrode; and an electrolyte between the positive electrode and the negative electrode. The lithium battery may have high capacity retention based on good thermal stability and high energy density.

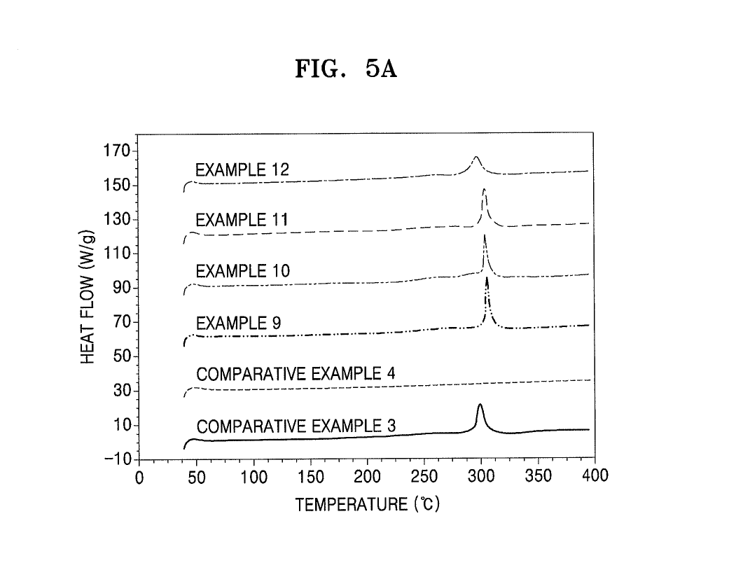

FIG. 4 illustrates an exploded perspective view of a lithium battery 100 according to an embodiment. Referring to FIG. 4, the lithium battery 100 may include a positive electrode 114, a negative electrode 112, a separator 113 disposed between the positive electrode 114 and the negative electrode 112, an electrolyte (not shown) impregnated in the positive electrode 114, the negative electrode 112, and the separator 113, a battery case 120, and a sealing member 140 for sealing the battery case 120. Referring to FIG. 4, the lithium battery 100 may have a configuration of the positive electrode 114, the negative electrode 112, and the separator 113 that are sequentially stacked and spirally-wound to be accommodated in the battery case 140,

The positive electrode 114 may include a current collector and a positive electrode active material layer formed on the current collector. As a positive electrode active material for forming the positive electrode active material layer, the composite positive electrode active material including a lithium transition metal oxide represented by at least one of Formulae 1 and 2 below; and the vanadium-based compound including polyanions may be used:

LiNiₓCo_{y}Mn_{z}O₂ <Formula 1>

In Formula 1, 0<x≦0.8, 0<y≦0.5, and 0<z≦0.5

aLi₂MnO₃.(1−a)LiMO₂ <Formula 2>

In Formula 2, 0<a<1 and M is at least one element selected from the group consisting of Al, Mg, Mn, Co, Cr, V, Fe, and Ni.

The composite positive electrode active material may include a vanadium-based compound that has a high theoretical capacity and includes a polyanion, such as phosphate-containing polyanion or sulfate-containing polyanion, having an equivalent or higher gravimetric energy density than lithium manganese oxide. A lithium battery including the composite positive electrode active material may have excellent thermal stability and high energy density.

In some other embodiments, the positive electrode 114 may include a lithium electrode.

The positive electrode active material layer may further include a binder.

The binder may adhere particles of the positive electrode active material to each other, as well as adhere the positive electrode active material to the current collector. Representative examples of the binder include polyamide imide, polyvinyl alcohol, carboxymethyl cellulose, hydroxypropyl cellulose, diacetyl cellulose, polyvinylchloride, carboxylated poly(vinyl chloride), polyvinyl fluoride, polymer including ethylene oxide, polyvinylpyrrolidone, polyurethane, polytetrafluoroethylene, polyvinylidene fluoride, polyethylene, polypropylene, styrene-butadiene rubber, acrylated styrene-butadiene rubber, epoxy resin, or nylon.

The current collector may be an Al current collector, as an example.

The positive electrode 114 may be prepared as follows: a positive electrode active material and a binder (and, optionally, a conducting agent) may be mixed in a solvent to prepare a composition for forming a positive electrode active material layer, and a current collector may be coated with the composition to prepare the positive electrode 114. The solvent used herein may include N-methylpyrrolidone. The amount of the solvent may be in a range of about 1 part to about 10 parts by weight based on 100 parts by weight of the positive electrode active material. When the amount of the solvent is within this range, an active material layer may be easily formed.

The positive electrode active material layer may further include a conducting agent. The conducting agent may be at least one selected from the group of carbon black, Ketjen black, acetylene black, artificial graphite, natural graphite, copper powder, nickel powder, aluminum powder, silver powder, and polyphenylene, as examples.

The amount of the binder and the conducting agent may be each in a range of about 2 parts to about 5 parts by weight based on 100 parts by weight of the positive electrode active material. The amount of the solvent may be in a range of about 1 part to about 10 parts by weight based on 100 parts by weight of the positive electrode active material. When the amount of the binder, the conducting agent, and the solvent are within these ranges, a positive electrode active material layer may be easily formed.

The negative electrode 112 may include a current collector and a negative electrode active material layer formed on the current collector. A suitable material available as a negative electrode active material for forming a negative electrode active material layer in the art may be used. Examples of the negative electrode active material include a lithium metal, a metal capable of alloying with lithium, a transition metal oxide, a material capable of doping and de-doping lithium, and a material capable of reversibly intercalating and deintercalating lithium ions.

Examples of the transition metal oxide include tungsten oxide, molybdenum oxide, titanium oxide, lithium titanium oxide, vanadium oxide, and lithium vanadium oxide.

The material capable of doping and de-doping lithium may be, for example, Si, SiOₓ (0<x≦2), a Si—Y alloy (wherein Y is an alkali metal, an alkali earth metal, an element of Groups 13 and 14, a transition metal, a rare earth element, or a combination thereof, except Si), Sn, SnO₂, or a Sn—Y alloy (wherein Y is an alkali metal, an alkali earth metal, an element of Groups 13 and 14, a transition metal, a rare earth element, or a combination thereof, except Sn), and at least one these examples may be mixed with SiO₂. Element Y used herein may be Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, or a combination thereof.

The material capable of reversibly inserting and deintercalating lithium ions may be a carbonaceous material, Any carbon-based negative electrode active material that is generally used in a lithium battery may be used. For example, the material capable of reversibly inserting and deintercalating lithium ions may be crystalline carbon, amorphous carbon, or a combination thereof. Examples of the crystalline carbon include natural or artificial graphite in amorphous, plate, flake, spherical, or fiber type. Examples of the amorphous carbon include soft carbon (low-temperature sintering carbon) or hard carbon, mesophase pitch carbide, and sintered coke.

The negative electrode active material layer may further include a binder. The binder used herein may be the same type as the one used in the positive electrode.

The negative electrode current collector may be a Cu current collector, as an example. For example, the negative electrode current collector may be made of stainless steel, aluminum, nickel, titanium, heat-treated carbon, copper or stainless steel having a surface-treated with carbon, nickel, titanium, or silver, or an aluminum-cadmium alloy. Fine irregularities may be formed on a surface of the negative electrode active material to strengthen binding forces between the negative electrode active materials. The negative electrode active material may be used in various forms, such as a film, a sheet, a foil, a net, a porous body, a foam body, and a non-woven body.

The negative electrode active material layer may further selectively include a conducting agent. The conducting agent used herein may be the same type as the one used in the positive electrode.

The negative electrode 112 may be prepared as follows: a negative electrode active material and a binder, and optionally, a conducting agent, may be mixed in a solvent to prepare a composition for forming a negative electrode active material layer. A current collector may be coated with the composition to prepare the negative electrode 112. The solvent used herein may be N-methylpyrrolidone, as an example.

The amount of the binder and the conducting agent may be each in a range of about 2 parts to about 5 parts by weight based on 100 parts by weight of the negative electrode active material. The amount of the solvent may be in a range of about 1 part to about 10 parts by weight based on 100 parts by weight of the negative electrode active material. When the amounts of the binder, the conducting agent, and the solvent are within these ranges, a negative electrode active material layer may be easily formed.

In some embodiments, a plasticizer may be added to the composition for forming the positive electrode active material layer and the composition for forming the negative electrode active material layer, so as to form pores inside electrode plates.

The electrolyte may include a non-aqueous organic solvent and a lithium salt.

The non-aqueous organic solvent may act as a medium where ions involved in an electrochemical reaction may be transferred.

The non-aqueous organic solvent may be a carbonate-based solvent, an ester-based solvent, an ether-based solvent, a ketone-based solvent, an alcohol-based solvent, or an aprotic solvent. Examples of the carbonate-based solvent include dimethyl carbonate (DMC), diethyl carbonate (DEC), dipropyl carbonate (DPC), methyl propyl carbonate (MPC), ethyl propyl carbonate (EPC), ethyl methyl carbonate (EMC), ethylene carbonate (EC), propylene carbonate (PC), or butylene carbonate (BC). Examples of the ester-based solvent include methyl acetate, ethyl acetate, n-propyl acetate, dimethyl acetate, methyl propionate, ethyl propionate, γ-butyrolactone, decanolide, valerolactone, mevalonolactone, or caprolactone. Examples of the ether-based solvent include dibutyl ether, tetraglyme, diglyme, dimethoxyethane, 2-methyltetrahydrofuran, or tetrahydrofuran. An example of the ketone-based solvent includes cyclohexanone. Examples of the alcohol-based solvent include ethyl alcohol and isopropyl alcohol. Examples of the aprotic solvent include a nitrile such as R—CN (wherein R is a straight chain, a branched chain, or a cyclic C₂-C₂₀ hydrocarbon group, including double bonds in an aromatic ring or an ether bond), an amide such as dimethylformamide, and dioxolane sulfolane such as 1,3-dioxolane.

The non-aqueous organic solvent may be a single solvent material or a mixture of one or more solvent materials. In the case of using the non-aqueous organic solvent as a mixture of one or more solvent materials, a mixing ratio of the solvent materials may be appropriately adjusted for a desired cell performance.

The lithium salt may be dissolved in an organic solvent such that the lithium salt may act as a source material for lithium ions in a battery to enable basic operation of the lithium battery. The lithium salt may be a material that stimulates the movement of lithium ions between the positive electrode and the negative electrode. Examples of the lithium salt include LiPF₆, LiBF₄, LiSbF₆, LiAsF₆, LiN(SO₂C₂F₅)₂, Li(CF₃SO₂)₂N, LiC₄F₉SO₃, LiClO₄, LiAlO₂, LiAlCl₄, LiN(CₓF₂ₓ₊₁SO₂)(C_{y}F_{2y+1}SO₂)(wherein x and y are each a natural number), LiCl, LiI, and LiB(C₂O₄)₂ (referred to as lithium bis(oxalato)borate (LiBOB)). At least one of these examples may be included as a supporting electrolyte. Here, the concentration of the lithium salt may be in a range of about 0.1 M to about 2.0 M. When the concentration of the lithium salt is within this range, the electrolyte may have appropriate conductivity and viscosity. In this regard, the electrolyte of the lithium battery may exhibit an excellent performance, and the lithium ions may be efficiently moved.

According to the types of the lithium battery, a separator 113 may be disposed between the positive electrode 114 and the negative electrode 112. The separator 113 may include polyethylene, polypropylene, or polyvinylidene fluoride, or may be formed as a multi-layered film consisting of two or more of the separator materials above. In some implementations, the separator 113 may be a mixed multi-layered film. Examples thereof include a two-layer separator consisting of polyethylene/polypropylene, a tri-layer separator consisting of polyethylene/polypropylene/polyethylene, and a tri-layer separator consisting of polypropylene/polyethylene/polypropylene.

The lithium battery may be classified as a lithium ion battery, a lithium ion polymer battery, and a lithium polymer battery, according to types of a separator and an electrolyte being used. The lithium battery may be classified as a cylindrical battery, a rectangular battery, a coin-type battery, or a pouch-type battery a according to the shape thereof. The lithium battery may be classified as a bulk-type battery and a thin film-type battery according to the size thereof. In addition, the lithium battery may be a lithium primary battery or a lithium secondary battery.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### EXAMPLE

### Preparation of Composite Positive Electrode Active Material

### Example 1

A Ni_{0.6}Co_{0.2}Mn_{0.2}(OH)₂ precursor was prepared by a general co-precipitation method, and the prepared Ni_{0.6}Co_{0.2}Mn_{0.2}(OH)₂ precursor was mixed with lithium cobalt oxide (Li₂CO₃). A predetermined amount of the mixture was then placed in a high-temperature electric furnace and heated at a heating rate of 2° C./min until the temperature reached 850° C. or 950° C., at which temperature the mixture was sintered for 10 hours to 12 hours. The atmosphere provided therein was an oxidizing atmosphere in which air was injected at a flow rate of 50 l/min so as to prepare LiNi_{0.6}Co_{0.2}Mn_{0.2}O₂.

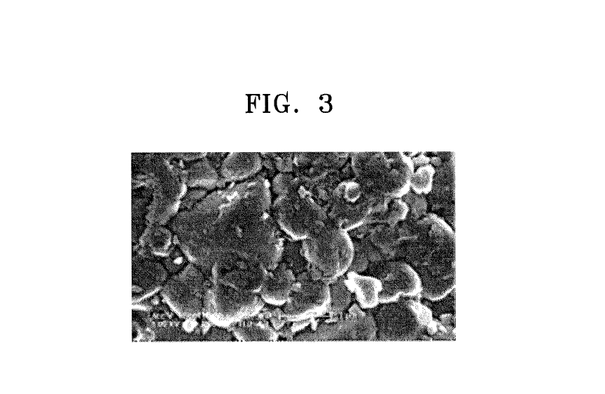

FIG. 2 is an SEM image of particles of LiNi_{0.6}Co_{0.2}Mn_{0.2}O₂. Referring to FIG. 2, it was confirmed that LiNi_{0.6}Co_{0.2}Mn_{0.2}O₂ had an average particle diameter D50 of 10 μm.

Next, Li₂CO₃, NH₄VO₃, and a reducing agent (NH₄)₂HPO₄ were mixed at a mixing ratio of 1.5 mol:2 mol:3 mol to prepare a mixture. The mixture was then sintered in a nitrogen atmosphere at a temperature of 800° C. for 10 hours, so as to prepare Li₃V₂(PO₄)₃.

FIG. 1 is an SEM image of particles of the Li₃V₂(PO₄)₃. Referring to FIG. 1, it was confirmed that the Li₃V₂(PO₄)₃ had a bimodal particle diameter distribution in which small particles were adhered to large particles, wherein the large particles had an average particle diameter D50 of about 20 μm and the small particles had an average particle diameter D50 of about 10 μm.

5 parts by weight of Li₃V₂(PO₄)₃ were mixed with 95 parts by weight of LiNiₓCo_{y}Mn_{z}O₂, thereby preparing a composite positive electrode active material.

### Example 2

A composite positive electrode active material was prepared in the same manner as in Example 1, except that 10 parts by weight of Li₃V₂(PO₄)₃ were mixed with 90 parts by weight of LiNiₓCo_{y}Mn_{z}O₂, instead of using 5 parts by weight of Li₃V₂(PO₄)₃ and 95 parts by weight of LiNiₓCo_{y}Mn_{z}O₂.

### Example 3

A composite positive electrode active material was prepared in the same manner as in Example 1, except that 20 parts by weight of Li₃V₂(PO₄)₃ were mixed with 80 parts by weight of LiNiₓCo_{y}Mn_{z}O₂, instead of using 5 parts by weight of Li₃V₂(PO₄)₃ and 95 parts by weight of LiNiₓCo_{y}Mn_{z}O₂.

### Example 4

A composite positive electrode active material was prepared in the same manner as in Example 1, except that 30 parts by weight of Li₃V₂(PO₄)₃ were mixed with 70 parts by weight of LiNiₓCo_{y}Mn_{z}O₂, instead of using 5 parts by weight of Li₃V₂(PO₄)₃ and 95 parts by weight of LiNiₓCo_{y}Mn_{z}O₂.

### Example 5

A composite positive electrode active material was prepared in the same manner as in Example 1, except that 40 parts by weight of Li₃V₂(PO₄)₃ were mixed with 60 parts by weight of LiNiₓCo_{y}Mn_{z}O₂, instead of using 5 parts by weight of Li₃V₂(PO₄)₃ and 95 parts by weight of LiNiₓCo_{y}Mn_{z}O₂.

### Example 6

A Ni_{0.6}Co_{0.2}Mn_{0.2}(OH)₂ precursor was prepared by a general co-precipitation method, and the prepared Ni_{0.6}Co_{0.2}Mn_{0.2}(OH)₂ precursor was mixed with lithium cobalt oxide (Li₂CO₃). A predetermined amount of the mixture was then placed in a high-temperature furnace and heated at a heating rate of 2° C./min until the temperature reached 850° C. or 950° C., at which temperature the mixture was sintered for 10 hours to 12 hours. The atmosphere provided therein was an oxidizing atmosphere in which air was injected at a flow rate of 50 l/min so as to prepare LiNi_{0.6}Co_{0.2}Mn_{0.2}O₂.

98.4 parts by weight of LiNi_{0.6}Co_{0.2}Mn_{0.2}O₂, 0.27 parts by weight of Li₂CO₃, 0.57 parts by weight of NH₄VO₃, and 0.74 parts by weight of a reducing agent (NH₄)₂HPO₄ were mixed together, and the mixture was sintered in a nitrogen atmosphere at a temperature of 800° C. for 10 hours so as to prepare a composite positive electrode active material in which Li₃V₂(PO₄)₃ was coated on a surface of LiNi_{0.6}Co_{0.2}Mn_{0.2}O₂ at a weight ratio of 1:99.

### Example 7

A Ni_{0.6}Co_{0.2}Mn_{0.2}(OH)₂ precursor was prepared by a general co-precipitation method, and the prepared Ni_{0.6}Co_{0.2}Mn_{0.2}(OH)₂ precursor was mixed with lithium cobalt oxide (Li₂CO₃). A predetermined amount of the mixture was then placed in a high-temperature electric furnace and heated at a heating rate of 2° C./min until the temperature reached 850° C. or 950° C., at which temperature the mixture was sintered for 10 hours to 12 hours. The atmosphere provided therein was an oxidizing atmosphere in which air was injected at a flow rate of 50 l/min so as to prepare LiNiₒ₆Co_{0.2}Mn_{0.2}O₂.

92.3 parts by weight of LiNi_{0.6}Co_{0.2}Mn_{0.2}O₂, 1.32 parts by weight of Li₂CO₃, 2.79 parts by weight of NH₄VO₃, and 3.61 parts by weight of a reducing agent (NH₄)₂HPO₄ were mixed together, and the mixture was sintered in a nitrogen atmosphere at a temperature of 800° C. for 10 hours so as to prepare a composite positive electrode active material in which Li₃V₂(PO₄)₃ was coated on a surface of LiNi_{0.6}Co_{0.2}Mn_{0.2}O₂ at a weight ratio of 5:95.

### Example 8

A Ni_{0.6}Co_{0.2}Mn_{0.2}(OH)₂ precursor was prepared by a general co-precipitation method, and the prepared Ni_{0.6}Co_{0.2}Mn_{0.2}(OH)₂ precursor was mixed with lithium cobalt oxide (Li₂CO₃). A predetermined amount of the mixture was then placed in a high-temperature electric furnace and heated at a heating rate of 2° C./min until the temperature reached 850° C. or 950° C., at which temperature the mixture was sintered for 10 hours to 12 hours. The atmosphere provided herein was an oxidizing atmosphere in which air was injected at a flow rate of 50 l/min so as to prepare LiNi_{0.6}Co_{0.2}Mn_{0.2}O₂.

84.99 parts by weight of LiNi_{0.6}Co_{0.2}Mn_{0.2}O₂, 2.57 parts by weight of Li₂CO₃, 5.41 parts by weight of NH₄VO₃, and 7.02 parts by weight of a reducing agent (NH₄)₂HPO₄ were mixed together, and the mixture was sintered in a nitrogen atmosphere at a temperature of 800° C. for 10 hours so as to prepare a composite positive electrode active material in which Li₃V₂(PO₄)₃ was coated on a surface of LiNi_{0.6}Co_{0.2}Mn_{0.2}O₂ at a weight ratio of 10:90.

FIG. 3 is an SEM image of particles of the composite positive electrode active material. Referring to FIG. 3, it was confirmed that Li₃V₂(PO₄)₃ particles having a bimodal particle diameter distribution filled voids on the surface of the LiNiₓCo_{y}Mn_{z}O₂ particles.

### Comparative Example 1

A Ni_{0.6}Co_{0.2}Mn_{0.2}(OH)₂ precursor was prepared by a general co-precipitation method, and the prepared Ni_{0.6}Co_{0.6}Mn_{0.2}(OH)₂ precursor was mixed with lithium cobalt oxide (Li₂CO₃). A predetermined amount of the mixture was then placed in a high-temperature furnace and heated at a heating rate of 2° C./min until the temperature reached 850° C. or 950° C., at which temperature the mixture was sintered for 10 hours to 12 hours. The atmosphere provided herein was an oxidizing atmosphere in which air was injected at a flow rate of 50 l/min so as to prepare a positive electrode active material of LiNi_{0.6}Co_{0.2}Mn_{0.2}O₂.

### Comparative Example 2

Li₂CO₃, NH₄VO₃, and a reducing agent (NH₄)₂HPO₄ were mixed at a mixing ratio of 1.5 mol:2 mol:3 mol to prepare a mixture. The mixture was then sintered in a nitrogen atmosphere at a temperature of 800° C. for about 10 hours so as to prepare a positive electrode active material of Li₃V₂(PO₄)₃.

### Preparation of Lithium Battery

### Example 9

The composite positive electrode active material of Example 1 and Ketjen black were mixed at a weight ratio of 92:4 in 4 parts % of N-methylpyrrolidone, so as to prepare a positive electrode active material slurry. The slurry was coated onto a 25 μm-thick aluminum current collector using a doctor blade method, and then dried at a temperature of 110° C. for 1 hour. Accordingly, a 20 μm-thick positive electrode active material layer was stacked on the aluminum current collector. The aluminum current collector was cut into a circle having a 16 mm diameter hole drilled therein, thereby preparing a positive electrode.

A lithium metal as a counter electrode with respect to the positive electrode, a microporous polypropylene separator (Celgard 3501), and an electrolyte including 1.3M LiPF₆ in a solvent (EC, EMC, and DMC mixed at a volume ratio of 3:4:3) were used to manufacture a coin-type half cell.

### Example 10

A coin-type half cell was manufactured in the same manner as in Example 9, except that the composite positive electrode active material of Example 2 was used instead of the composite positive electrode active material of Example 1.

### Example 11

A coin-type half cell was manufactured in the same manner as in Example 9, except that the composite positive electrode active material of Example 3 was used instead of the composite positive electrode active material of Example 1.

### Example 12

A coin-type half cell was manufactured in the same manner as in Example 9, except that the composite positive electrode active material of Example 4 was used instead of the composite positive electrode active material of Example 1.

### Example 13

A coin-type half cell was manufactured in the same manner as in Example 9, except that the composite positive electrode active material of Example 5 was used instead of the composite positive electrode active material of Example 1

### Example 14

A coin-type half cell was manufactured in the same manner as in Example 9, except that the composite positive electrode active material of Example 6 was used instead of the composite positive electrode active material of Example 1

### Example 15

A coin-type half cell was manufactured in the same manner as in Example 9, except that the composite positive electrode active material of Example 7 was used instead of the composite positive electrode active material of Example 1

### Example 16

A coin-type half cell was manufactured in the same manner as in Example 9, except that the composite positive electrode active material of Example 8 was used instead of the composite positive electrode active material of Example 1

### Comparative Example 3

A coin-type half cell was manufactured in the same manner as in Example 9, except that the positive electrode active material of Comparative Example 1 was used instead of the composite positive electrode active material of Example 1.

### Comparative Example 4

A coin-type half cell was manufactured in the same manner as in Example 9, except that the positive electrode active material of Comparative Example 2 was used instead of the composite positive electrode active material of Example 1.

### Evaluation of Lithium Battery Performance

### Evaluation Example 1

### Electrode Density Measurement

3.0 g of the composite positive electrode active materials of Examples 1-5 and the positive electrode active material of Comparative Example 1 were added to a mold having an area of 3.14 cm², and the mold was packed at a pressure of 2.6 ton/cm² to measure the density of the materials. The results are shown in Table 1 below.

TABLE 1

| Division | Pellet density (g/cc) |
|---|---|
| Example 1 | 3.32 |
| Example 2 | 3.39 |
| Example 3 | 3.46 |
| Example 4 | 3.49 |
| Example 5 | 3.41 |
| Comparative Example 1 | 3.27 |

Referring to Table 1, it was confirmed that the composite positive electrode active materials of Examples 1-5 had better electrode density than the positive electrode active material of Comparative Example 1.

### Evaluation Example 2

### Evaluation in Thermal Characteristics

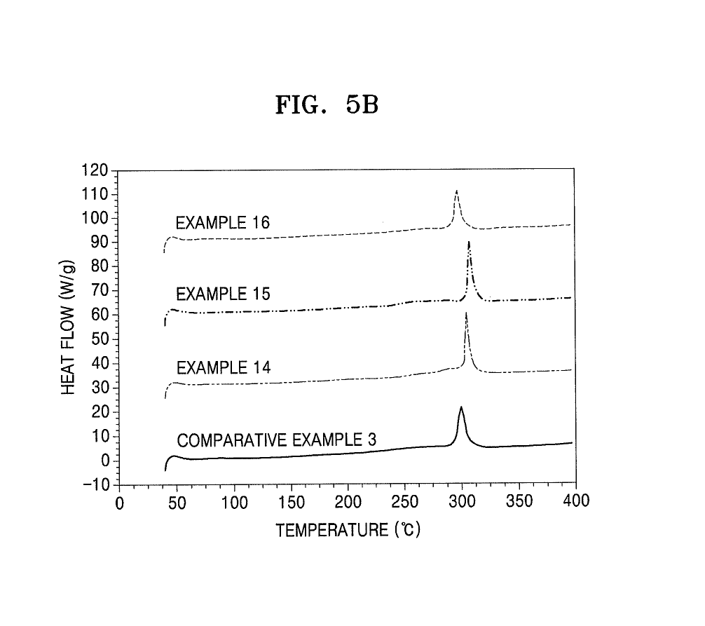

The coin-type half cells of Examples 9-12 and 14-16 and Comparative Examples 3 and 4 were charged until a voltage of the cells reached 4.4 V, and then, the charged cells were disassembled to obtain the composite positive electrode active materials of Examples 1-4 and 6-8 and the positive electrode active materials of Comparative Examples 1 and 2. The materials obtained therefrom and an electrolyte including 1.3M LiPF₆ added in a mixed solvent of EC:EMC:DMC at a volumetric ratio of 3:4:3 were used together to be prepared as a sample. Such a sample of the composite positive electrode active material or the positive electrode active material was used to measure a calorific value (J/g) thereof using a differential scanning calorimeter (DSC) (TA Instruments) set at a heating rate 10° C./min under an N₂ atmosphere at a temperature of 50° C. to 400° C. The results are shown in Table 2 below and FIGS. 5A and 5B.

TABLE 2

| Division | Calorific value (J/g) |
|---|---|
| Example 9 | 1350 |
| Example 10 | 1200 |
| Example 11 | 1150 |
| Example 12 | 950 |
| Example 14 | 1300 |
| Example 15 | 1250 |
| Example 16 | 1200 |
| Comparative Example 3 | 1400 |
| Comparative Example 4 | 50 |

Referring to Table 2 and FIGS. 5A and 5B, it was confirmed that the composite positive electrode active materials of Examples 1-4 and 6-8 included in the coin-type half cells of Examples 9-12 and 14-16 had less variation in calorific values than those of the positive electrode active material, i.e., LiNi_{0.6}Co_{0.2}Mn_{0.2}O₂, of Comparative Example 1 included in the coin-type half cell of Comparative Example 3.

Therefore, in preparation of the coin-type half cells of Examples 9-12 and 14-16, a composite positive material was prepared by mixing the positive electrode active material Li₃V₂(PO₄)₃ included in the coin-type half cell of Comparative Example 4 and having excellent effects in terms of thermal stability with the positive electrode active material LiNi_{0.6}Co_{0.2}Mn_{0.2}O₂ of Comparative Example 1 included in the coin-type half cell of Comparative Example 3 and having reduced thermal stability, or by coating a surface of the positive electrode active material. Accordingly, it was confirmed that the prepared coin-type half cells had improved thermal stability.

### Evaluation Example 3

### Charge:Discharge Capacity Measurement

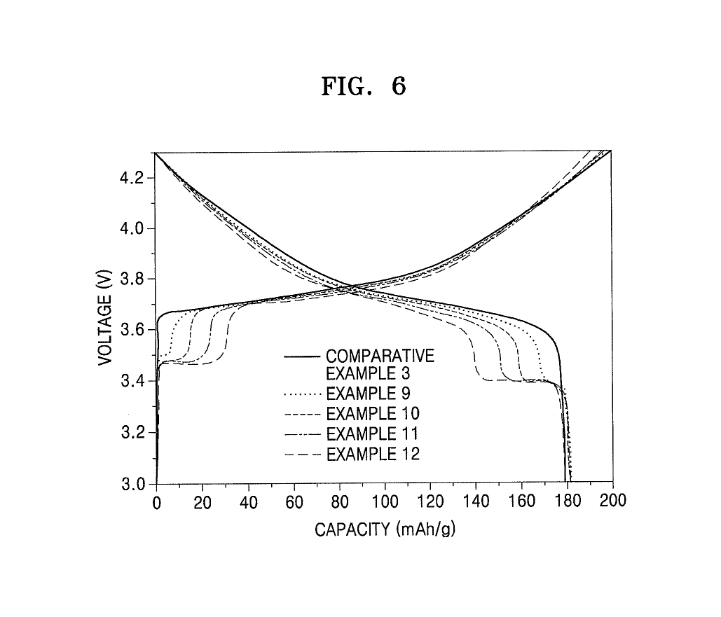

The coin-type half cells of Examples 9-12 and Comparative Example 3 were charged under a constant current of 0.1 C until a voltage thereof reached 4.3 V to measure charge capacity. Afterwards, the coin-type half cells were rested for 10 minutes, and discharged under a constant current of 0.1 C until a voltage thereof reached 3.0 V to measure discharge capacity. The results are shown in Table 3 below and FIG. 6. Here the charge-discharge efficiency was obtained by Equation 1 below.

Charge-discharge efficiency (%)=[Discharge capacity/Charge capacity]×100 [Equation 1]

TABLE 3

| | Charge | Discharge | Charge-discharge |
|---|---|---|---|
| | capacity | capacity | efficiency |
| Division | (mAh/g) | (mAh/g) | (%) |
| Example 9 | 197.9 | 180.7 | 91.3 |
| Example 10 | 196.6 | 181.1 | 92.1 |
| Example 11 | 195.6 | 181.0 | 92.5 |
| Example 12 | 191.8 | 178.5 | 93.1 |
| Comparative Example 3 | 199.1 | 177.9 | 89.3 |

Referring Table 3 and FIG. 6, it was confirmed that the coin-type half cells of Examples 9-12 had higher charge-discharge efficiency than the coin-type half cell of Comparative Example 3.

By way of summation and review, as a positive electrode active material of the lithium battery, currently, lithium cobalt oxide (LiCoO₂) is a material that is widely used. However, in consideration of small and expensive reserves of cobalt (Co) as a starting material of the positive electrode active material, and concerns about toxicity to the human body and environmental pollution, a positive electrode active material to replace lithium cobalt oxide is desirable.

Examples of an oxide that has a structure capable of intercalating lithium ions and that includes lithium and a transition metal include lithium manganese oxide, which that is relatively inexpensive and includes highly stable manganese (Mn), and lithium-nickel-cobalt-manganese-oxide, which exhibits an equal or higher cell performance than that of lithium cobalt oxide. However, the lithium-nickel-cobalt-manganese-oxide may have disadvantages of poor thermal stability, and in this regard, the improvement of the thermal stability is desirable.

As described above, according to the one or more of the above embodiments, a composite positive electrode active material includes a vanadium-based compound including a polyanion and has features of excellent thermal stability and a bimodal diameter distribution. A lithium battery employing a positive electrode that includes the composite positive electrode may accordingly improve the thermal stability thereof and increase electrode density for an excellent capacity thereof.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope thereof as set forth in the following claims.

What is claimed is:

1. A composite positive electrode active material, comprising:
a lithium transition metal oxide represented by at least one of Formulae 1 and 2 below; and
a vanadium-based compound including a polyanion,
LiNiₓCo_{y}Mn_{z}O₂ <Formula 1>
wherein in Formula 1,
0<x≦0.8, 0<y≦0.5, and 0<z≦0.5
aLi₂MnO₃.(1−a)LiMO₂ <Formula 2>
wherein in Formula 2,
0<a<1 and M is at least one element selected from aluminum (Al), magnesium (Mg), manganese (Mn), cobalt (Co), chromium (Cr), vanadium (V), iron (Fe), and nickel (Ni).

2. The composite positive electrode active material as claimed in claim 1, wherein the vanadium-based compound includes a PO₄³⁻ polyanion.

3. The composite positive electrode active material as claimed in claim 1, wherein the vanadium-based compound includes Li₃V₂(PO₄)₃.

4. The composite positive electrode active material as claimed in claim 1, wherein the vanadium-based compound is included as particles having a bimodal particle diameter distribution.

5. The composite positive electrode active material as claimed in claim 4, wherein particles in the bimodal particle distribution include large particles having an average particle diameter (D50) in a range of about 7 μm to about 20 μm.

6. The composite positive electrode active material as claimed in claim 5, wherein the particles in the bimodal particle diameter distribution include the large particles and further include small particles having an average particle diameter D50 in a range of about 0.1 μm to about 10 μm.

7. The composite positive electrode active material as claimed in claim 1, wherein the vanadium-based compound is included in a range of about 0.1 parts to about 40 parts by weight based on 100 parts by weight of a total weight of the composite positive electrode active material.

8. The composite positive electrode active material as claimed in claim 1, wherein the lithium transition metal oxide is included as particles having an average particle diameter D50 in a range of about 10 μm to about 20 μm.

9. The composite positive electrode active material as claimed in claim 1, wherein the vanadium-based compound is coated on at least a portion of a surface of the lithium transition metal oxide.

10. The composite positive electrode active material as claimed in claim 1, wherein the vanadium-based compound is discontinuously coated on a surface of the lithium transition metal oxide.

11. The composite positive electrode active material as claimed in claim 10, wherein the vanadium-based compound is included in a range of about 0.01 parts to about 20 parts by weight based on 100 parts by weight of a total weight of the composite positive electrode active material.

12. A lithium battery, comprising:
a positive electrode including the composite positive electrode active material as claimed in claim 1;
a negative electrode facing the positive electrode; and
an electrolyte between the positive electrode and the negative electrode.
